(19) United States
(12) Patent Application Publication
(10) Pub. No.: US 2005/0276051 A1
(43) Pub. Date: Dec. 15, 2005

(54) Illumination system and method

(76) Inventors: Madeline Elaine Caudle, Denver, CO (US); Louise Alice Hurlbut, Denver, CO (US); James Franklin Hurlbut, Denver, CO (US)

Correspondence Address: Madeline Caudle, 630 Vine St, Denver, CO, 80206, US

(21) Appl. No.: 10/853,217

(22) Filed: May 26, 2004

(51) Int. Cl. F21V 21/26

(52) U.S. Cl. 362/276

(57) ABSTRACT

An illumination system is set forth that includes motion detector, an acoustic detector or noise amplifier, a time delay system, an illumination device such as an LED or incandescent bulb and an AC input device. The purpose is to allow children, elderly and others to sleep without a nightlight that is illuminated constantly. The device provides light only when needed by the occupant of the space or a person entering the space and is triggered by a specified level of noise or motion. Studies have shown that nearsightedness can be caused by not allowing the eyes to be in total darkness for long periods such as overnight. Current nightlights stay on all night, whereas this device turns on and off automatically allowing for long periods of darkness.

### BACKGROUND

Infants and small children who sleep with a night light or other brighter light source are more likely to grow up nearsighted than children who sleep in the dark.

One of the causes of nearsightedness, myopia, has been attributed to sleeping with the lights on according to a group of researchers at the University of Pennsylvania. Dr. Richard Stone, a pediatric ophthalmologist and one of the authors of the report, discovered eyes might need a period of darkness to develop properly. This is especially true for children under two because their eyes are developing rapidly from birth to two year of age. The study was published in Nature (1999; 399:113).

The results of the study indicated that 10% of children grew up nearsighted that slept in a dark room, 34% with a night-light and 55% with a room light. The recommendation from the study was to reduce the amount of light as much as possible during the children's first two years of life.

After two years of age when children develop a fear of the dark, it is difficult to accommodate the children's desire for light and the parents desire for a dark room. It can be a struggle between the parents and the children making bedtime difficult.

Some attempts to solve this problem have been made including a light that is motion and/or audio activated. This is an incomplete solution as in U.S. Pat. No. 5,763,872, the Ness patent, U.S. Pat. No. 5,307,051, the Sedlmayr patent. In the Ness patent, an electro-phosphorescent light is activated when motion near the device is detected by the device. In the Sedlmyar patent a light and audio output is activated in response to an audio input. While these night-lights apparatus have some benefits, they are not completely effective for the needs of small children. There are many circumstances in which either motion or audio signals indicate a need for light in the child's room. Neither of these devices can respond to both audio and motion stimulus.

The objective of this invention is to provide light only when needed thus limiting the light at night that can cause nearsightedness. The length of the time the light is on can be determined by the user and is controlled by the integral timer. It is a further objective of this device to be stimulated by a variety of input stimulus including motion, sound of the child or adult in the room. It is the intent that the device not be activated by pets.

While the device is intended for infants, toddlers and other children, the device provides many advantages for infirmed and elderly as well. For these groups, several of these devices can be used through the living area to provide lighting at night when the use of brighter lights is undesirable.

### INVENTION SUMMARY

The present invention incorporates a night light apparatus that is activated by sound or motion in which the length of time the light stays on is controlled by a timer. The device can sense motion in a prescribed range both distance and height which activates the light. The light can also be activated by directional sound, primarily within the room in which it is located. Once the light is one it will stay illuminated for a predetermined period of time. The time is set by a timer on the device. The device can also be turned on and off with a switch on the unit.

When the device is turned on the light will come on and stay on for a prescribed period of time after which the light switches off. If the child makes a prescribed level of noise during the night the light will again illuminate and stay on for the predetermined period of time. If the child moves significantly such as standing up in a crib or getting out of bed the light is activated by the motion diction device. Again the light will stay on for the predetermined period of time.

Each occurrence when the light is activated the timer is started and will control the illumination of the light source for the predetermined period of time. Once the light is on it is not reactivated by an additional motion or sound. It is only reactivated from the non-illuminated state.

The night light device is the output part of this invention. The light output can be an incandescent light bulb, LED or phosphorescent light. It can take a variety of forms and includes a housing, a motion detection device, a sound detection device, and a relay timer. The invention can use a variety of power sources either electrical or battery. The housing can take many forms including child friendly and likeable objects, simple and functional designs, or fashionable designs.

The motion device detects motion within a specified range in distance and in height. The objective is to detect significant motion of the children and adults in such that light would be preferred. The objective is to limit the smaller movements such as rolling over in bed from activating the device. Additionally, the range of the motion detector can be altered to eliminate motions close to the floor such as pets.

A predetermined level of audio such as a child crying or a normal adult voice activates the sound device. The sound must be loud enough to activate the light not the sound of light footsteps, yawning etc.

Both the motion and sound detection devices are connected to a relay that has a variable time set. When the light is activated by the sound or motion device, the timer begins. The light stays on as long as the circuit is open. When the prescribed time is reached, the circuit is closed and the light goes off.

The motion and sound detection devices may be integral or separate.

### BRIEF DESCRIPTION OF THE DRAWINGS

FIG. 1: is the schematic block diagram of the basic elements and the electrical circuit for the described invention

FIG. 2: an illustration of the rear view of the invention

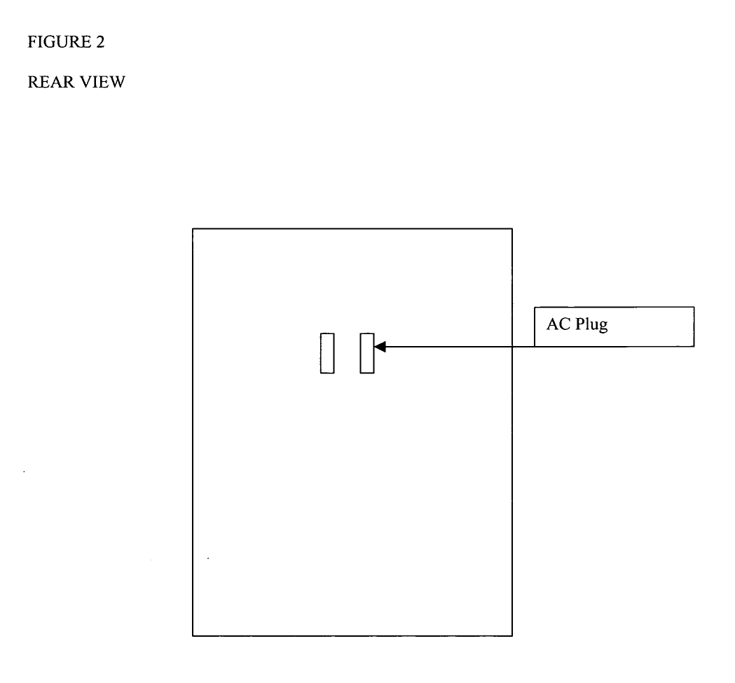

FIG. 3: an illustration of the front of the invention with separate motion and sound detectors

FIG. 4: an illustration of the invention with integrated motion and sound detectors

### DETAILED DESCRIPTION OF THE PREFERRED EMBODIMENT

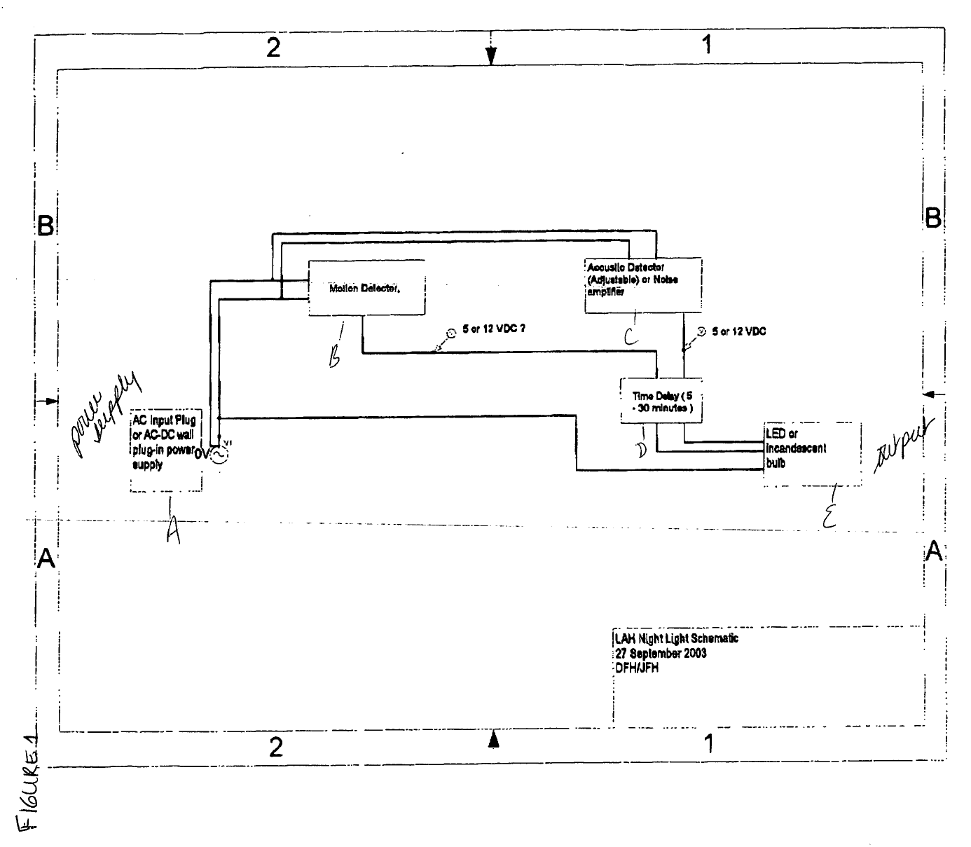

FIG. 1. A night light 100 that stays on for only a prescribed period of time that is activated by predetermined sound or motion thresholds for the purpose of providing a sense of security and visibility for movement in the night or darkness. The invention preferably operated as follows:
When the device 100 is plugged in or turned on and the motion sensor 150 determines that the motion detected exceeds a predetermined range of motion (the range usually consisting of a range less than 20 feet), a relay 110 is activated which illuminates the bulb 120.
The relay 110 keeps the circuit 130 open for an amount of time that has either been set by the user or is otherwise a default provided with the night-light 100.
When the time limit is reached the relay 110 is closed and the bulb 120 is turned off.
This same process is repeated when the device 100 is turned on and when the audio sensor 160 determines that the sound in the room exceeds a predetermined level of sound.
Once again, the relay 110 is activated which illuminates the bulb 120.
The relay 110 keeps the circuit open for the amount of time that has been set by the user or some other default length of time. When the time limit is reached the relay 110 is closed and the bulb 120 is turned off.

These two sensors 150, 160 may be independent (meaning that either will trigger the relay 110) or may be interdependent (meaning that both must reach a threshold before the relay 110 is triggered). The thresholds used by each sensor 150, 160 may also vary depending on whether there is some motion and sound or just motion or just sound. For example, the sensors 150, 160 could be programmed in such a way that very large sound could be enough to independently activate the relay 110 while lighter sounds would only be effective to activate the relay when combined with at least some detected motion. The same rules could also be applied to the motion sensor 160.

The device 100 can be constructed in accordance with the schematic in FIG. 1 and is preferably composed of the following:
An audio sensor 150 for sensing of sound from any source at a prescribed minimum level and activating the light and timing relay. Phillips Semiconductor is one source for such a device
Motion sensor 160 the sensing of a range of motion at prescribed distances and heights and activating the light and timing relay. Lumanila or Ningbo are sources for these devices.

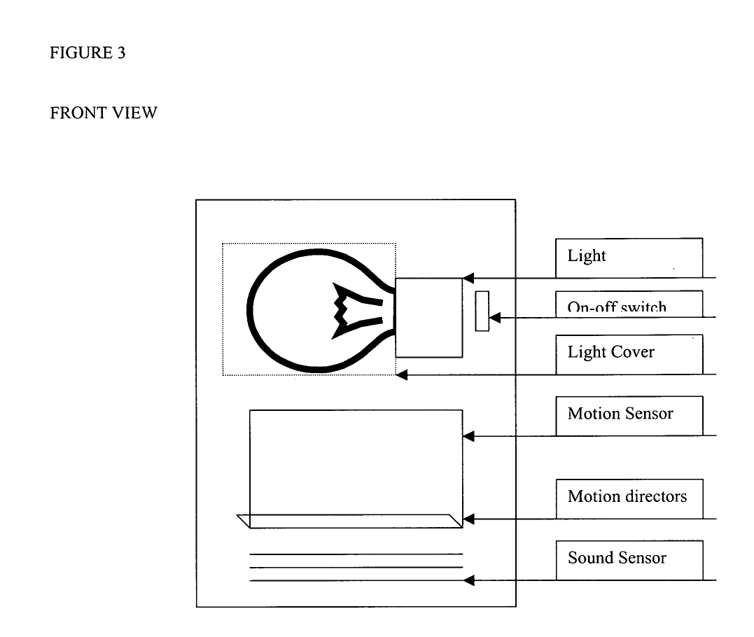

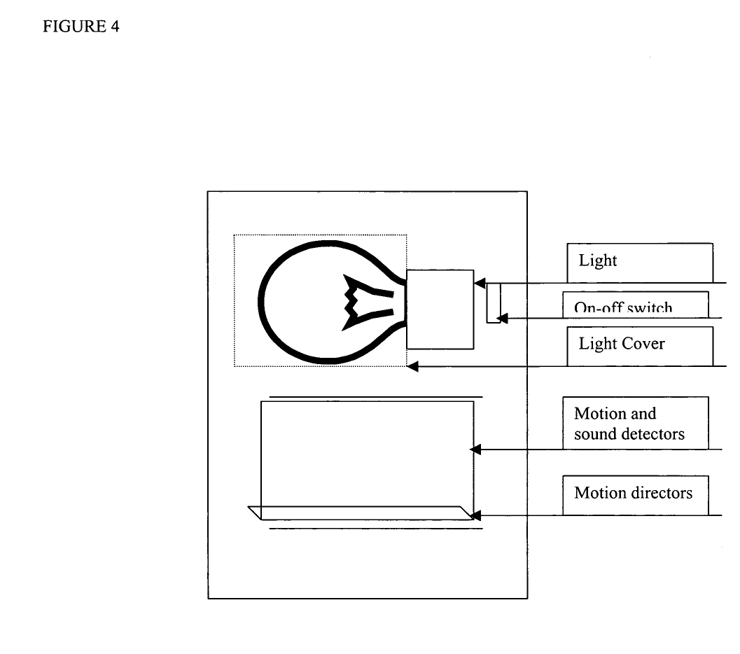

The motion sensor 160 and the audio sensor 150 may be one integral unit or two separate units. FIG. 3 illustrates the invention with separate sensor units 150, 160. FIG. 4 illustrates the invention with integrated sensor units 150, 160. The function of the invention is the same in either case.

The preferred methodology for using the light will be described with reference to the flowchart in FIG. 5.
Step 500, parent turns on unit with the on/off switch 140.
Step 510, parent moves in the room and the motion detector is activated, thus activating the relay 110 and the bulb 120.
Step 530, parent puts child in crib or bed for the night and leaves the room.
Step 540, after a short period of time, which can be adjusted by the user, the relay timer 110 elapses closing the circuit and turning off the bulb 120.
Step 550, The relay 110 is automatically reset.
Step 560 the child wakes in the middle of the night and cries loudly or otherwise moves around thus reaching a threshold in the audio 150 or motion sensors 160.
Step 570 the sensor is activated, thus activating the relay and the light.
Step 580 after the relay 110 has elapsed for the appropriate time interval, the circuit is closed thus turning off the bulb 120.

The foregoing description of the preferred embodiment of the invention has been presented for the purposes of illustration and description. Any number of other basic features, functions, or extensions of the foregoing method and systems would be obvious to those skilled in the art in light of the above teaching. For example, while we discuss this as bulb being activated it could be another output devise. For these reasons, this description is not intended to be exhaustive or to limit the invention to the precise forms disclosed. It is intended that the scope of the invention be limited not by this detailed description but rather by the claims appended hereto.

1. An illumination system comprising:
a bulb for illumination
an audio sensor for sensing the presence of sound and including at least one threshold;
a motion sensor for sensing the presence of motion and including at least one threshold;
an electrical relay that is in communication with the audio sensor, the motion sensor and the bulb; and
a power source, such as a plug into an electrical outlet or battery, for powering the sensors and for illuminating the bulb when the relay is closed.

2. The system of claim 1, wherein the motion sensor is a device that detects motion within a specified range in distance and in height. The objective is to detect significant motion of the children and adults in such that light would be preferred. The objective is to limit the smaller movements such as rolling over in bed from activating the device. Additionally, the range of the motion detector can be altered to eliminate motions close to the floor such as pets

3. The system of claim 1, wherein the audio sensor is set to a predetermined level of audio such as a child crying or a normal adult voice activates the sound device. The sound must be loud enough to activate the light not the sound of light footsteps, yawning etc.

4. The system of claim 1, wherein the electrical relay is programmed to close whenever motion is detected by the motion sensor above a first programmed threshold.

5. The system of claim 1, wherein the electrical relay is programmed to close whenever sound is detected by the audio sensor above a first programmed threshold.

6. The system of claim 4, wherein the electrical relay is programmed to close when an amount of sound exceeding a second programmed threshold is detected by the audio sensor and an amount of motion exceeding a second programmed threshold is detected by the motion sensor.

7. The system of claim 5, wherein the electrical relay is programmed to close when a certain amount of sound is detected by the audio sensor and a certain amount of motion is detected by the motion sensor.

8. The system of claim 6, wherein the first threshold is greater than the second threshold.

9. An illumination method comprising the steps of
When the device 100 is plugged in or turned on and the audio sensor 150 determines that the motion detected exceeds a predetermined range of motion (the range usually consisting of a range less than 20 feet), a relay 110 is activated which illuminates the bulb 120.
The relay 110 keeps the circuit 130 open for an amount of time that has either been set by the user or is otherwise a default provided with the night-light 100.
When the time limit is reached the relay 110 is closed and the bulb 120 is turned off.
This same process is repeated when the device 100 is turned on and when the audio sensor 160 determines that the sound in the room exceeds a predetermined level of sound.
Once again, the relay 110 is activated which illuminates the bulb 120.
The relay 110 keeps the circuit open for the amount of time that has been set by the user or some other default length of time. When the time limit is reached the relay 110 is closed and the bulb 120 is turned off.

10. A motion and audio system that activates an output device
Can be either a dual motion and audio diction device or one device for audio and one device for motion
